(19) United States
(12) Patent Application Publication
(10) Pub. No.: US 2021/0156084 A1
(43) Pub. Date: May 27, 2021

(54) Lightweight Carpet Tile and Method

(71) Applicant: Paul Walker, Dalton, GA (US)

(72) Inventor: Paul Walker, Dalton, GA (US)

(21) Appl. No.: 17/164,822

(22) Filed: Feb. 1, 2021

Related U.S. Application Data
(63) Continuation of application No. 15/840,453, filed on Dec. 13, 2017, now abandoned.
(60) Provisional application No. 62/460,328, filed on Feb. 17, 2017.

(51) Int. Cl. D06N 7/00

(52) U.S. Cl. CPC D06N 7/0086; C09J 7/38; D06N 2201/0254; D06N 2201/0263; D06N 2211/066; D10B 2401/08; D06N 2213/066; D06N 2213/068; D10B 2331/02; D10B 2321/022; D06N 2213/063; D06N 2203/068; C09J 2203/314; Y10T 428/14; D06N 7/0081

(57) ABSTRACT

A novel carpet tile is provided with a roller applied polyurethane adhesive layer at a rate of less than 45 ounces per square yard, resulting in a lightweight backing with exceptional dimensional stability.

This patent application is a continuation of U.S. Ser. No. 15/840,453, abandoned Feb. 1, 2021, which claims priority to U.S. Provisional Application Ser. No. 62/460,328, filed Feb. 17, 2017.

### FIELD OF THE INVENTION

The present invention relates to improved methods for manufacturing lightweight carpet tile products especially suited for the residential market and the structure of those tiles, but also adaptable to commercial use.

### BACKGROUND OF THE INVENTION

The carpet tile market has evolved into distinct categories for commercial and residential markets. The commercial market for hotels, hospitality facilities, and public buildings is exemplified by high traffic, mostly foot traffic, but also rolling carts and equipment. In this market, there is little demand for plush surfaces that would readily show wear in lanes of traffic. Carpet tiles designed for the commercial market have evolved into largely a low loop pile surface category or in some cases cut/loop with dense cut pile areas, and the structure of these tiles is intended to withstand heavy commercial use. Thus, nylon yarns are preferred and are tufted into a primary backing to create the greige, and a secondary backing is attached. The secondary and even tertiary backings consist of multiple layers to provide dimensional stability and durability under heavy use.

Some carpet tiles are specifically designed for residential use, previously typified by Berkshire Flooring carpet tiles that were available through Home Depot and other direct-to-consumer outlets. The tiles were inexpensive and typically featured a polyester fiber tufted to a relatively higher height with a relatively lower stitch density than commercial carpets, having a face weight of about 25 ounces per square yard. The amount of face yarn by weight is not necessarily particularly different than face yarn on a commercial carpet tile; however, the weight is often achieved through a higher pile height rather than closely spacing lower tufts of yarn. After attaching the secondary backing, the carpet is sprayed with an adhesive and married to release sheet to provide peel-and-stick functionality. The backing is typically a woven or non-woven fabric, and the residential carpet tile is sufficiently light that it can be cut to fit with relatively ease by a consumer. In the manufacturing process, the light weight product can be cut by a variety of devices to create the tiles. In contrast, the commercial carpet tiles have more substantial laminated secondary and tertiary backing layers so that tiles must be die-cut. On-site fitting of commercial tiles may require professional cutting tools to fit the tiles around obstructions or irregular edges.

An aspect of residential carpet tiles that has traditionally added to their manufacturing cost is the use of latex backing and the cost of backing materials. Accordingly, by utilizing a polyurethane roller coating process to apply a polyurethane adhesive backing to the greige, lightweight nonwoven secondary backing fabrics such as nonwoven felt, needlepunch, or relatively light leno weave of slit film and spun olefin yarns fabrics can be used. Thus, cost can be removed from the manufacture of residential carpet tiles, while providing surprising dimensional stability, tuft bind, and other performance metrics.

### SUMMARY OF THE INVENTION

The applicant has developed a process for the application of polyurethane coating on greige and the use of inexpensive secondary backings that are suitable for use with sprayed-on peel-and-stick adhesives that allow the resulting carpet to be easily cut to tile dimensions with blades passing longitudinally or laterally across the carpet rather than having to be die cut.

Furthermore, the tile made according to this process and evaluated under ASTM D7570, Evaluation of Dimensional Stability of Pile Floor Coverings, has demonstrated minimal expansion or shrinkage under a variety of test conditions. Furthermore, the foaming of the polyurethane backing can be controlled to provide some cushion without the necessity of attaching a separate cushion or pad layer to the tile. The placement of the cushion between the greige and secondary backing fabric may be particularly helpful in minimizing the creation of visual ledges between tiles as weight is applied near the edge of one tile but not upon the adjacent tile. With the use of appropriate backing fabrics, the polyurethane backing can provide suitable dimensional stability, and the tufted fabric may be manufactured with sufficient tuft density to be suitable for commercial use, as well.

### BRIEF DESCRIPTION OF THE DRAWINGS

The accompanying drawings which are incorporated and which constitute a part of this specification illustrate an exemplary embodiment of the present invention and together with the detailed description set forth below explain principles of the invention wherein:

FIG. 1 is a sectional view of an exemplary loop pile carpet tile material made that can be manufactured utilizing a polyurethane coating process;

FIG. 2 is a sectional view of an exemplary cut pile carpet tile material that can be manufactured utilizing a polyurethane coating process, having a peal and stick adhesive backing and release sheet;

FIG. 3 is a schematic representation of a manufacturing process for the creation of carpet according to the invention;

FIG. 4 is a schematic representation of the finishing process to convert the manufactured carpet into adhesive floor tile.

### DETAILED DESCRIPTION OF THE INVENTION

A detailed explanation of a polyurethane coating process is set forth in U.S. Pat. No. 7,638,008, which is incorporated herein in its entirety. The roller coating process of this patent and related improvements as described in U.S. Pat. No. 10,472,764, is advantageously used in the manufacture of lightweight carpet products.

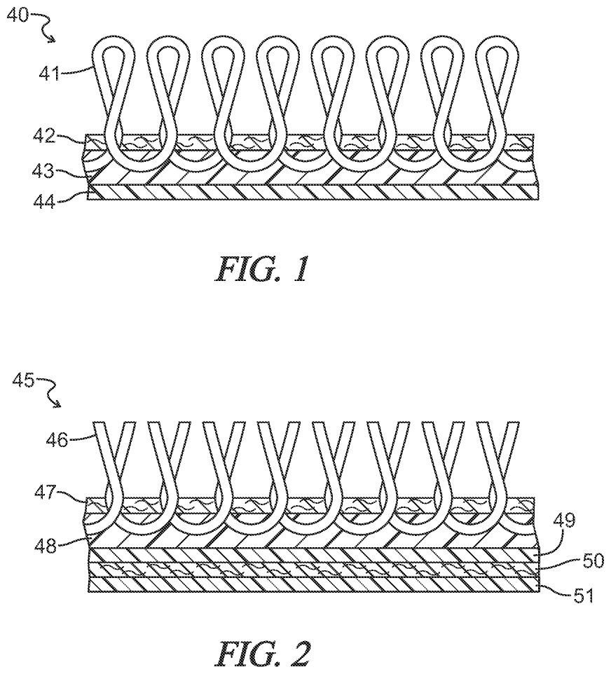

FIG. 1 depicts a sectional view of a loop pile carpet tile 40 with looped bights of yarn 41 penetrating a primary backing material 42, bound in position with a polyurethane adhesive layer 43, and an attached secondary backing fabric of 44. The carpet density can be substantially less than 3000, or less than 2500, or even less than 2000. Carpet density is calculated using the following formula:

Carpet face weight×36/carpet pile height=density, measured in ounces per cubic yard

The pile height is the length of the fiber from tip to the carpet backing. In the above formula, pile height should be represented as a fraction of an inch, reflected in decimal format. For example, a pile height of half of an inch would be represented as 0.5; a pile height of a quarter of an inch would be 0.25.

For commercial application, the pile height would typically be reduced, the spacing of stitches in the carpet would be more compressed, and the secondary backing fabric 44 would be selected for greater stability than in residential applications. An additional tertiary backing could even be applied to maximize stability, durability, or other metrics.

FIG. 2 is a sectional view of a cut pile carpet tile 45 with cut bights of yarn 46 tufted through primary backing 47 bound in position by polyurethane adhesive layer 48, secondary backing fabric 49, pressure sensitive adhesive layer 50, and release sheet 51.

It will be understood that some foaming of the polyurethane adhesive layers, 43, 48 can provide cushioning, or an additional layer of material can be adhered to the exemplary carpets of FIGS. 1 and 2 to provide a cushioned carpet tile product. Such additional cushioning layer would commonly be affixed below the secondary backing fabrics 44, 49. For commercial or heavy-duty applications, a tertiary backing material may even be applied to the cushion layer. Commercial or hospitality sizes may also need to be more varied, ranging from 9 to 12 inches long by 36 or 48 inches in length to 36-inch square configurations

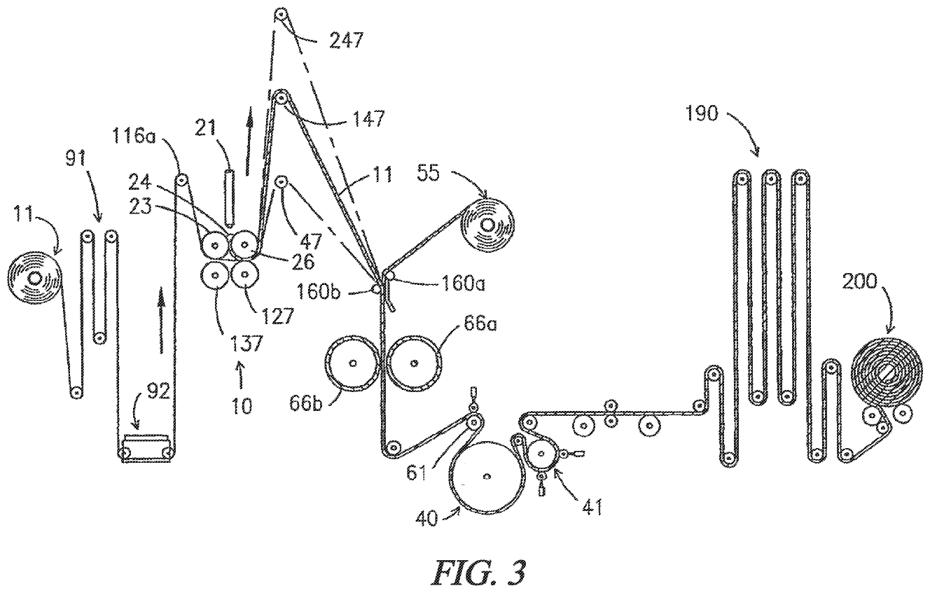

The schematic representation of FIG. 3 illustrates an exemplary system for application of polyurethane adhesive material and provides a method to adjust the distance between the polyurethane application rollers 23, 26 and marriage point with a secondary backing fabric. Specially, the unbacked greige 11 is passed through a tenter frame 91 and J-box 92 to condition and control the greige prior to application of the polyurethane material. The polyurethane material is prepared with a substantial load of filler material such as calcium carbonate to minimize cost. From 250 to 700 parts of filler can be used for every 100 parts of polyol, where polyol and isocyanate are the critical polyurethane forming ingredients.

The greige 11 proceeds past application rollers 23, 26 and polyurethane is pressured into the greige by upward pressure from support rollers, and particularly the pressure applied by adjustable roller 127 to communicate pressure upward against the greige and effect the amount of polyurethane material being applied while imbedding the viscous polyurethane into the fibers of the primary backing. The polyurethane material is applied at a weight of between 14 and 45 ounces per square yard, and preferably less than 30, 25, or even 20, ounces per square yard for residential carpet tile. Weights of 24 to 45 ounces of material are preferred for commercial or hospitality carpet tile. A moveable tenter roll 147 is adjustable between a low position 47 and a high position 247 shown in phantom, and the illustrated intermediate position 147 to allow the length of coated greige intermediate the application rolls 23, 26 and nip rolls 160a, 160b at the marriage point with secondary backing material 55 to be increased or decreased and thereby effect the completeness of the reaction of the polyurethane material at the marriage point. Either nip rolls 160a, 160b or subsequent rubber coated pressure rolls 66a, 66b should be pressure controlled to ensure complete marriage of the secondary backing fabric to the coated greige 11. Residential carpet tile will typically use an economical secondary backing material such as nonwoven felt, needlepunch, or a leno weave of slit film and spun olefin yarns (Action Bac®) fabrics, and these fabrics may weigh only about 1.5 to 7 ounces per square yard. In this fashion, the entire secondary backing, comprising the polyurethane and secondary backing fabric will have a combined weight of less than about 33 ounces per square yard.

Thereafter the carpet passes around first heat can 40 and second heat can 41 to iron the secondary backing fabric 55 to the greige and speed the curing process. The carpet then goes through accumulator 190 to roll-up as the finished carpet product 200.

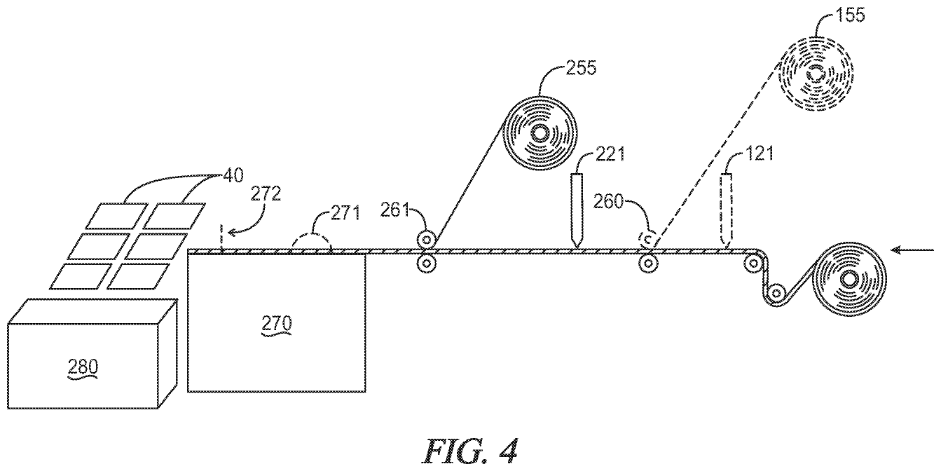

As shown in the schematic representation of FIG. 4, the carpet with secondary backing applied 200 may proceed through an additional step of applying adhesive from sprayer 121 to affix a cushioning layer 155 at marrying roller 260 all shown in phantom), and also proceeds through the application of a pressure sensitive adhesive from sprayer 221 and a release sheet 255 using marrying roller 261 to insure uniformity. Then the adhesive backed carpet material proceeds to cutting station 270 and is cut into modular pieces, typically 2-foot squares (though smaller sizes down to about 18-inch squares are also useful), by a cutting process. In the case of commercial tile, it is frequently necessary to employ a die-cut process, however with light weight residential tile, other cutting processes including the use of rotary blades 271, cutting longitudinally, and blades 272 cutting laterally, or cutting wires may be employed. Cutting processes with blades or wires that pass laterally or longitudinally through the carpet are faster, less expensive, and more easily maintained than die cutting apparatus. The resulting carpet tiles 40 are boxed 280 and shipped for sale. Boxes may preferably contain between about 8 and 24 carpet tiles.

The resulting carpet tiles exhibit unusual dimensional stability for a tile product not including a rigid backing layer such as fiberglass reinforced fabric. In ASTM D7570 testing such lightweight polyurethane backed tile typically provide variations of less than 0.5% on most measurements during varied exposures to conditions of heat and moisture. The typical measurements are taken for:

a) Original measurement in machine direction

b) Original measurement in cross direction

c) Two hours in drying oven at 60° C.

d) Two hours submerged in 0.1% detergent solution at 20° C.

e) Twenty-four hours in drying oven at 60° C.

f) Forty-eight hours conditioning at 20° C. and 65% relative humidity

In many instances, variations for measurements (c)-(f) may vary less than 0.3%, or even 0.1%. In commercial applications, such a rigid backing layer may be added to provide even greater durability and achieve variations of less than 0.05%.

Although a preferred embodiment of the present invention has been disclosed herein, it will be understood that various substitutions and modifications may be made to the disclosed embodiment described herein without departing from the scope and spirit of the present invention as recited in the appended claims.

Having thus set forth the nature of the invention, what is claimed herein is:

1. A rectangular carpet tile product consisting essentially of:
a greige with a primary backing material having tufted face yarns extending from a face side and an opposite backstitch side;
a single layer of polyurethane compound applied by roller coating at a rate of less than 30 ounces per square yard to the backstitch side of the greige;
a secondary backing fabric having a front side adhered to the single layer of polyurethane compound;
a pressure sensitive adhesive on an opposite back side of the secondary backing fabric; and
a release sheet covering the pressure sensitive adhesive;
wherein the carpet tile is dimensionally stable in ASTM D7570 testing and has edges with a length of about 18 to 24 inches.

2. The carpet tile of claim 1 wherein the tufted face yarns are selected from the group of polyester yarns and polypropylene yarns.

3. The carpet tile of claim 1 wherein the secondary backing material is selected from the group of woven fabrics, nonwoven felts, needlepunch fabrics, and leno weave fabrics.

4. The carpet tile of claim 1 wherein the polyurethane compound comprises polyol, isocyanate, and filler, and the ratio of filler to polyol is greater than 2.5 to 1.

5. The carpet tile of claim 1 wherein the rectangular carpet tile product is cut to size by blades passing laterally or longitudinally through the tufted greige and secondary backing.

6. The carpet tile of claim 6 wherein the polyurethane compound is applied at a rate of less than 25 ounces per square yard.

7. The carpet tile of claim 1 wherein the carpet density is less than 2000 oz/yd³.

8. The carpet tile of claim 5 wherein the polyurethane compound is foamed.

9. The carpet tile of claim 1 wherein the variations in ASTM D7570 testing are less than 0.5%.

10. A rectangular carpet tile product comprising a greige with a primary backing material having tufted face yarns extending from a face side and an opposite backstitch side; a single layer of polyurethane compound applied by roller coating to the backstitch side of the greige and a front side of a secondary backing fabric adhered to the single layer of polyurethane compound; the polyurethane compound comprising polyol, isocyanate, and filler, with the ratio of filler to polyol is greater than 2.5 to 1, and the polyurethane compound applied to the backstitch side at a rate of between 14 and 30 ounces per square yard; wherein the carpet tile is dimensionally stable in ASTM D7570 testing without additional stabilizing or reinforcing layers.

11. The carpet tile of claim 10 wherein the secondary backing material is selected from the group of woven fabrics, nonwoven felts, needlepunch fabrics, and leno weave fabrics.

12. The carpet tile of claim 10 wherein the carpet density is less than 2500 oz/yd³.

13. The carpet tile of claim 10 wherein the variations in ASTM D7570 testing are less than 0.3%.

14. The carpet tile of claim 10 wherein a cushioning layer is affixed to an opposite bottom side of the secondary backing fabric.

15. The carpet tile of claim 10 wherein a tertiary backing is affixed below the secondary backing.

16. The carpet tile of claim 15 wherein the variations in ASTM D7570 testing are less than 0.1%.

17. The carpet tile of claim 15 wherein the carpet density is less than 3000 oz/yd³.

18. The carpet tile of claim 10 being cut to size by blades passing laterally or longitudinally through the tufted greige and secondary backing to have edges with lengths of about 9 to 48 inches.

19. The carpet tile of claim 10 wherein the tufted face yarns are nylon.

20. The carpet tile of claim 10 wherein the polyurethane compound is applied at a rate of between 20 and 30 ounces per square yard.
